(19) United States
(12) Patent Application Publication
(10) Pub. No.: US 2016/0341145 A1
(43) Pub. Date: Nov. 24, 2016

(54) CONTROL DEVICE FOR SPARK-IGNITION ENGINE

(71) Applicant: MAZDA MOTOR CORPORATION, Hiroshima (JP)

(72) Inventors: Kyohei YASUDA, Hiroshima (JP); Takafumi NISHIO, Otake-shi, Hiroshima (JP)

(73) Assignee: MAZDA MOTOR CORPORATION, Hiroshima (JP)

(21) Appl. No.: 14/783,024

(22) PCT Filed: Apr. 3, 2014
(86) PCT No.: PCT/JP2014/001943

§ 371 Date: Oct. 7, 2015

(30) Foreign Application Priority Data
Apr. 15, 2013 (JP) 2013-084714

(51) Int. Cl. F02D 41/40; F02D 41/00; F02M 61/14; F02D 41/26; F02B 17/00; F02M 61/04

(52) U.S. Cl. CPC F02D 41/40; F02B 17/005; F02M 61/04; F02M 61/14; F02D 41/26; F02D 41/0002

(57) ABSTRACT

A controller (an engine controller 100) allows a fuel to be fed into a cylinder 11 within a range from an intake stroke to a compression stroke, if an engine body (an engine 1) is at a low temperature which is equal to or below a predetermined temperature and is under a load which is equal to or greater than a predetermined load. The controller instructs a fuel injection valve 53 to inject a greater amount of the fuel during the compression stroke than during the intake stroke if the content of an unconventional fuel in the fuel is higher than a predetermined level, and to inject a greater amount of the fuel during the intake stroke than during the compression stroke if the content of the unconventional fuel in the fuel is equal to or lower than the predetermined level.

### TECHNICAL FIELD

The present disclosure relates to a control device for a spark-ignition engine, and more particularly relates to a control device for a spark-ignition engine configured to be fed with a fuel including at least one of gasoline or an unconventional fuel having, at or below a specific temperature, a lower vaporization rate than gasoline.

### BACKGROUND ART

In recent years, biofuels have caught some attention from the viewpoint of environmental issues such as global warming. As a result, flexible fuel vehicles (FFVs) that can run with a fuel including gasoline and bioethanol, for example, at any arbitrary blend ratio have already been put on the market. Ethanol contents of fuels for FFVs vary depending on the blend ratio of gasoline and ethanol for the fuels available on the market. Examples of such variations range from E25 (i.e., a blend of 25% ethanol and 75% gasoline) to E100 (i.e., 100% ethanol), or from E0 (i.e., 100% gasoline) to E85 (i.e., a blend of 85% ethanol and 15% gasoline). Note that E100 here includes E100 containing approximately 5% of water (i.e., 5% water and 95% ethanol) that has not been sufficiently removed through the distillation processes of ethanol which is still left there.

In such FFVs, the properties of their fuels vary depending on the ethanol content of the fuels. In other words, gasoline, which is a multicomponent fuel, has a standard boiling point falling within the range of 27° C. to 225° C. FIG. 2 shows a change in the distillation ratio of gasoline with temperature. As can be seen from FIG. 2, the vaporization ratio of gasoline is relatively high even if its temperature is relatively low. In contrast, ethanol, which is a single component fuel, has a standard boiling point of 78° C. Thus, ethanol at a relatively low temperature has a vaporization rate of 0%, which is lower than that of gasoline. On the other hand, ethanol at a relatively high temperature has a vaporization rate of 100%, which is higher than that of gasoline. Hence, when the engine temperature is low, i.e., equal to or lower than a predetermined temperature, the fuel vaporizability in a cylinder decreases as the ethanol content of the fuel rises or the engine temperature falls. Specifically, if the vaporization rate is defined as the ratio by weight of the fuel contributing to combustion to the fuel fed into the cylinder, the vaporization rate decreases as the ethanol content rises or as the engine temperature falls. When the engine is run cold with E100, for example, there arises a problem that the low vaporization rate causes deterioration in ignitability and/or combustion stability of an air-fuel mixture. In particular, this problem is serious with the water-containing E100.

For example, PATENT DOCUMENT 1 discloses an FFV system which extracts a fuel having a high gasoline content from a main tank storing a fuel that contains gasoline and ethanol at any given blend ratio; transfers the extracted fuel to a sub-tank which provided separately from the main tank; and stores the fuel in the sub tank. The engine system disclosed in PATENT DOCUMENT 1 allows the sub-tank to store constantly a fuel with stabilized vaporizability. Hence, when the engine system disclosed in PATENT DOCUMENT 1 uses a fuel having a high ethanol content, the system blends, at an appropriate ratio, the fuel stored in the main tank with the fuel stored in the sub-tank and having a high gasoline content, under a running condition (e.g., when the engine system is run cold) causing a decrease in the ignitability and/or combustion stability of the air-fuel mixture. Thus, the engine system injects, into an intake port of the engine, a blended fuel having a higher gasoline content than the fuel stored in the main tank. Consequently, the engine system disclosed in PATENT DOCUMENT 1 uses the fuel having a high gasoline content and stored in the sub-tank to increase the vaporization rate of the fuel, under such a running condition as to cause a decrease in the vaporization rate. Thus, the engine system ensures the ignitability and/or the combustion stability of the air-fuel mixture when the engine system is run cold. That is to say, the engine system disclosed in PATENT DOCUMENT 1 changes the properties of the fuel into predetermined ones under a specific running state, in order to ensure the ignitability and/or combustion stability of the fuel.

On the other hand, PATENT DOCUMENT 2 discloses an FFV engine system without such a sub-tank. Instead, the engine system includes a fuel injection valve configured to directly inject a fuel into a cylinder. This PATENT DOCUMENT 2 discloses fuel injection control at the start of an engine. Specifically, the engine system of PATENT DOCUMENT 2 increases a fuel pressure and injects the high-pressure fuel into a cylinder during the compression stroke at a cold start of the engine when the temperature of the engine and the vaporizability of the fuel are low and when the fuel has a high ethanol content and the fuel injection amount is large, in view of the fact that a theoretical air fuel ratio of ethanol is smaller than that of gasoline and the fact that the fuel injection amount needs to be increased when using a fuel having a high ethanol content compared to when using a fuel having a high gasoline content. This promotes the vaporizability of the fuel and facilitates cold starting of the engine. Furthermore, even if the temperature of the engine is low, the engine system determines that the fuel be easily vaporizable when the ethanol content of the fuel is low, and injects the fuel into a cylinder during the intake stroke without increasing the fuel pressure in order to start the engine. Hence, the engine system disclosed in PATENT DOCUMENT 2 changes its fuel injection mode when the engine is started, depending on the ethanol content of the fuel.

### CITATION LIST

### Patent Document

PATENT DOCUMENT 1: Japanese Patent Application No. 2010-133288
PATENT DOCUMENT 2: Japanese Patent Application No. 2010-37968

### SUMMARY OF THE INVENTION

### Technical Problem

The configuration that needs a sub-tank as disclosed in PATENT DOCUMENT 1 has two fuel feeding systems, which complicates, and increases the cost of, the engine system. Hence, there is a demand for a configuration without a sub-tank as disclosed in PATENT DOCUMENT 2.

On the other hand, as to an FFV, the change in the ethanol content of the fuel to be fed changes the ethanol content of the fuel stored in its main tank, as described above. Hence, not only the ignitability and/or combustion stability of the air-fuel mixture, but also the exhaust emission performance need to be constantly ensured regardless of the properties of the fuel stored in the main tank.

For example, the amount of the fuel to be injected is relatively large, when the engine is at a low temperature after its start and is under a relatively heavy load. If the ethanol content of the fuel is high in such a running state, the fuel injection amount increases and the vaporization rate decreases compared with the case where gasoline is used. Hence, the vaporization of the fuel needs to be promoted in view of the ignitability and/or combustion stability of the air-fuel mixture. In contrast, ethanol generates much less smoke than gasoline does, since the combustion temperature of the ethanol is relatively low and the molecules of the ethanol include oxygen. Hence, even if the engine is under a relatively heavy load, a countermeasure against smoke is rarely needed when the fuel has a relatively high ethanol content.

In contrast if the ethanol content of the fuel is low (i.e., if the gasoline content is high), the fuel injection amount decreases comparatively and the vaporization rate is relatively high. Thus, the vaporization of the fuel hardly needs to be promoted. On the other hand, compared with ethanol, gasoline tends to generate smoke much more easily. Thus, a countermeasure against smoke is required when the engine is running under a relatively heavy load.

In view of the forgoing background, it is therefore an object of the present disclosure to constantly ensure, regardless of the properties of a fuel, not only the ignitability and/or combustion stability of an air-fuel mixture but also the exhaust emission performance for an engine fed with the fuel, including at least one of gasoline or an unconventional fuel, of which the vaporization rate is lower, at or below a specific temperature, than that of gasoline.

### Solution to the Problem

A technique disclosed herewith relates to a control device for a spark-ignition engine. This control device for a spark-ignition engine comprises: an engine body configured to run with a fuel including at least one of gasoline and an unconventional fuel, of which the vaporization rate is lower, at or below a specific temperature, than that of the gasoline; a fuel feeder which includes a fuel injection valve injecting the fuel, and is configured to feed the fuel through the fuel injection valve into a cylinder provided for the engine body; a throttle valve configured to have an increased opening when the engine body is under a heavy load, and a decreased opening when the engine body is under a light load; and a controller configured to operate the engine body by controlling at least the fuel feeder.

The controller is configured to allow the fuel to be fed into the cylinder, within a range from an intake stroke to a compression stroke, if the engine body is at a low temperature which is equal to or below a predetermined temperature, and is under a load which is equal to or greater than a predetermined load, and instruct the fuel injection valve (i) to inject a greater amount of the fuel during the compression stroke than during the intake stroke if the content of the unconventional fuel in the fuel is higher than a predetermined level, and (ii) to inject a greater amount of the fuel during the intake stroke than during the compression stroke if the content of the unconventional fuel in the fuel is equal to or lower than the predetermined level

Here, the “unconventional fuel, of which the vaporization rate is lower, at or below a specific temperature, than that of gasoline” may be a single component fuel, for example. Specifically, examples of such unconventional fuels include alcohols such as ethanol and methanol. A specific example of the alcohol may be a biogenic alcohol such as bioethanol made from sugar cane or corn.

Moreover, the “fuel including at least one of an unconventional fuel or gasoline” is any one of a fuel that is a blend of the unconventional fuel and gasoline, a fuel consisting essentially of the unconventional fuel alone, and a fuel consisting essentially of gasoline alone. The blend ratio of the unconventional fuel and gasoline is not particularly limited but may be any given blend ratio. If the unconventional fuel is ethanol, the “fuel” fed to the engine body includes a fuel having any ethanol content. Specifically, the fuel may fall within the range of E25 in which 25% of ethanol is blended with gasoline to E100 consisting 100% of ethanol. Furthermore, the “fuel” here may also have any given ethanol content and may fall within the range of gasoline (i.e., E0) to E85 having a blend of 85% ethanol and gasoline. Furthermore, the “fuel including at least one of an unconventional fuel or gasoline” may contain water. Hence, E100 containing approximately 5% of water is also included in the “fuel” here. In the case where a fuel having a different unconventional fuel content (including a fuel having no content of unconventional fuel) is fed every time refueling is made, the content of the unconventional fuel, included in the fuel to be fed to the engine body, will change occasionally within a predetermined range. Note that the alcohol content in the fuel may be detected or estimated by various methods.

The “vaporization rate” may be defined herein as a ratio by weight of the fuel contributing to combustion to the fuel fed into the cylinder. This vaporization rate may be calculated based on a detection value of an O₂ sensor attached to an exhaust passageway of the engine. Under a condition that the temperature of the engine body is at or below a predetermined temperature, the vaporization rate may decrease as the content of the unconventional fuel in the fuel increases or as the temperature of the engine body falls.

The “fuel injection valve” may be a fuel injection valve which directly injects the fuel into a cylinder. In addition to a fuel injection valve of such a direct injection type, the engine body may further include a fuel injection valve injecting the fuel into the intake port.

The situation where “the engine body is at a low temperature which is equal to or below a predetermined temperature” is a situation with a temperature at which the vaporization rate of the fuel, including the unconventional fuel, decreases. For example, a temperature at the cold-running phase of the engine is one such low temperature. If the unconventional fuel is ethanol (i.e., with a standard boiling point of 78° C.), the predetermined temperature may be, but does not have to be, approximately 20° C.

The situation where “the engine body is under a load which is equal to or greater than a predetermined load” means that the load of the engine body is relatively heavy. The situation where “the engine body is under a load which is equal to or greater than a predetermined load” may also mean that the engine body is running in the heavy load range when the load range of the engine is evenly divided into two equal ranges (namely, a light load range and the heavy load range) or that the engine body is running in the medium and heavy load ranges when the load range of the engine is evenly divided into three equal ranges (namely, a light load range, a medium load range, and a heavy load range). The predetermined load may be, but does not have to be, approximately Ce=0.4.

According to the configuration described above, if the engine body is at a low temperature which is equal to or below the predetermined temperature (i.e., at such a temperature as to cause a fuel with a high unconventional fuel content to have a decreased vaporization rate), and is under a load which is equal to or greater than the predetermined load, the controller switches the fuel injection modes to be executed within a phase ranging from the intake stroke to the compression stroke, depending on the content of the unconventional fuel in the fuel.

In other words, the fuel injection valve injects a greater amount of the fuel during the compression stroke than during the intake stroke if the content of the unconventional fuel is higher than a predetermined level (i.e., if the content of gasoline is low). This includes a situation where the amount of the fuel to be injected during the intake stroke is reduced to zero, and the fuel is injected during the compression stroke alone.

During the compression stroke, the fuel is directly injected into the cylinder. This enables promoting the vaporization of the fuel by utilizing a rise in the temperature in the cylinder caused by adiabatic compression along with the progress of the compression stroke. In particular, the engine body is under a load which is equal to or greater than the predetermined load, and the manifold vacuum is relatively low. Hence, the promotion of the fuel vaporization utilizing the manifold vacuum cannot be expected very much. Moreover, when the unconventional fuel is alcohol, the fuel injection amount at the theoretical air fuel ratio is greater than that of gasoline, and the resulting fuel injection period becomes relatively long. Consequently, the manifold vacuum cannot be sufficiently utilized. When the manifold vacuum cannot be substantially utilized, the fuel injection during the compression stroke enables promoting the vaporization of the fuel, and is very effective. The vaporization rate of the fuel decreases since the content of the unconventional fuel in the fuel is high, and, furthermore, the temperature of the engine is relatively low. However, the compression stroke injection promotes the vaporization of the fuel. As a result, the ignitability and/or combustion stability of the air-fuel mixture are/is successfully ensured.

In contrast, the fuel injection valve injects a greater amount of the fuel during the intake stroke than during the compression stroke if the content of the unconventional fuel is equal to or lower than the predetermined level (i.e., if the content of gasoline is high). This includes a situation where the amount of the fuel to be injected during the compression stroke is reduced to zero, and the fuel is injected during the intake stroke alone.

Since the content of gasoline in the fuel is high, a high vaporization rate is ensured even if the temperature of the engine is relatively low. Hence, even if the manifold vacuum cannot be utilized, the fuel is successfully vaporized through the intake stroke injection. Moreover, the high gasoline content reduces the fuel injection amount and shortens the fuel injection period comparatively. This allows for facilitating the use of the manifold vacuum. To the contrary, the injection of the fuel into the cylinder during the compression stroke is disadvantageous in homogenizing the air-fuel mixture because the intake flow in the cylinder is weak and the period of time between the start of the fuel injection and the ignition becomes shorter. As a result, the fuel having a high gasoline content could generate smoke.

The intake stroke injection described above is advantageous in homogenizing the air-fuel mixture because this injection utilizes a strong intake flow and a sufficiently long air-fuel mixture creating period. Thus, when the content of the unconventional fuel in the fuel is low (i.e., when the content of gasoline in the fuel is high), generation of smoke is either successfully avoided or reduced to say the least. Consequently, the exhaust emission performance is ensured.

Note that if the unconventional fuel is alcohol such as ethanol, its combustion temperature is lower than that of gasoline and/or the molecules of the alcohol include oxygen. Hence, even if a fuel having a high ethanol content is injected during the compression stroke, the alcohol is much less likely to generate smoke than gasoline does.

The controller may be configured to allow the fuel to be injected during both the intake and compression strokes if the content of the unconventional fuel is higher than the predetermined level, and to allow the fuel to be injected during the intake stroke alone if the content of the unconventional fuel is equal to or lower than the predetermined level.

As described above, executing the compression stroke injection when the content of the unconventional fuel is higher than the predetermined level (i.e., when the vaporization rate is low) promotes the vaporization of the fuel, which is advantageous in improving the ignitability and/or combustion stability of the air-fuel mixture.

In addition, the engine body is under a relatively heavy load, and therefore, the fuel injection amount increases accordingly. Besides, a relatively low temperature of the engine body further increase the fuel injection amount, taking the low vaporization rate of the fuel into consideration. That is to say, the fuel injection amount is increased in advance such that a required amount of the vaporized fuel is obtained. Hence, when the fuel injection amount increases, a sufficient fuel injection period cannot be ensured during the compression stroke alone. In the configuration described above, however, the intake stroke injection is executed in addition to the compression stroke injection. This ensures a sufficiently long fuel injection period and extends the air-fuel mixture creating period. Furthermore, this configuration also allows for the homogenization of the air-fuel mixture by utilizing the intake flow. Hence, the split injections during the intake stroke and compression stroke injections are advantageous in the ignitability and the combustion stability of the air-fuel mixture. The split injections are also advantageous since they ensure a sufficiently long fuel injection period, even when the unconventional fuel is alcohol and the resulting fuel injection amount increases compared with gasoline because of the higher alcohol content in the fuel.

Meanwhile, if the content of the unconventional fuel in the fuel is equal to or below the predetermined level and if the gasoline content is relatively high, the fuel is injected during the intake stroke injection alone. Specifically, omitting the compression stroke injection enables avoiding generation of smoke. On the other hand, even if the intake stroke injection alone is executed, the fuel may be vaporized, and, when the gasoline content is relatively high, the fuel injection period becomes relatively short. Hence, this is beneficial in utilizing the manifold vacuum. Consequently, the ignitability and combustion stability of the air-fuel mixture are ensured.

The fuel injection valve may directly inject the fuel into the cylinder, if the content of the unconventional fuel is higher than the predetermined level, the controller is configured to allow the fuel to be injected through the fuel injection valve into the cylinder during a first period of the intake stroke and during the compression stroke, and if the content of the unconventional fuel is equal to or lower than the predetermined level, the controller may further be configured to allow the fuel to be injected through the fuel injection valve into the cylinder during each of a second period and a third period of the intake stroke, the second and third periods being later than the first period.

In a configuration in which the fuel is directly injected into a cylinder, it is beneficial to take into consideration the position of the piston in the cylinder and a fuel injection timing.

In other words, if the content of the unconventional fuel is higher than the predetermined level, the fuel is injected into the cylinder through the fuel injection valve in the first period of the intake stroke. This first period precedes the second and third periods. The first period may also be defined as the first half period when the intake stroke is divided into the first and second halves. Injecting the fuel into the cylinder during the first half of the intake stroke enables utilizing strong manifold vacuum immediately after the intake valve has opened. This is advantageous in vaporizing the fuel. Moreover, injecting the fuel during the first half of the intake stroke ensures a sufficiently long air-fuel mixture creating period.

Moreover, if the content of the unconventional fuel is higher than the predetermined level, the fuel is injected into the cylinder through the fuel injection valve during the compression stroke. This allows for the vaporization of the fuel by utilizing a high temperature in the cylinder under a condition that the vaporization rate is low. Here, it is beneficial to delay the fuel injection during the compression stroke until the temperature in the cylinder rises high enough to create an advantageous condition for the vaporization of the fuel. The fuel injection during the compression stroke may be executed, for example, during the second half of the compression stroke. Note that it is beneficial to ensure a sufficiently long air-fuel mixture creating period between the end point of the fuel injection and the ignition time point. Hence, if the fuel injection amount is relatively large to make the fuel injection period long, for example, the fuel injection may be started during the first half of the compression stroke.

In contrast, if the content of the unconventional fuel is equal to or lower than the predetermined level and if the fuel has a higher gasoline content, the fuel is injected into the cylinder through the fuel injection valve in the second and third periods of the intake stroke. Specifically, the split injections are executed during the intake stroke, and the second and third periods of the split injections may be later than the first period and may be in the second half of the intake stroke. If the fuel has a high gasoline content, the vaporization of the fuel does not have to be promoted, as described above. Consequently, the fuel does not have to be injected into the cylinder during the first half of the intake stroke for utilizing the manifold vacuum. To the contrary, in the first half of the intake stroke, the piston is located at a relatively upper position in the cylinder. Hence, the fuel injected into the cylinder could collide against this piston, and, for example, affect the creation of the air-fuel mixture. Meanwhile, in the second half of the intake stroke, the piston is located at a relatively low position, which enables avoiding the risk that the fuel injected into the cylinder could collide against the piston. Moreover, the second half of the intake stroke is advantageous in forming a homogeneous air-fuel mixture by utilizing a strong intake flow in the cylinder. Hence, generation of smoke is effectively reduced when the content of the unconventional fuel is equal to or lower than the predetermined level and the fuel has a high gasoline content. This also contributes to the improvement of combustion stability.

The controller may be configured to allow a single injection of the fuel to be executed during the intake stroke if the engine body is under a lighter load than the predetermined load

If the engine body is under a load which is smaller than the predetermined load, the throttle valve is decreased due to relatively low charging efficiency. As a result, the manifold vacuum becomes high. Hence, the controller executes a single injection of the fuel during the intake stroke if the engine body is under a load which is smaller than the predetermined load. This promotes the vaporization of the fuel by the flash-boiling effect utilizing the manifold vacuum, regardless of the content of the unconventional fuel in the fuel. As a result, not only the ignitability and/or combustion stability of the air-fuel mixture but also the exhaust emission performance are successfully ensured.

### Advantages of the Invention

As can be seen from the foregoing description, the control device for a spark-ignition engine instructs the fuel injection valve to inject a greater amount of fuel during the compression stroke than during the intake stroke if the content of unconventional fuel in the fuel is relatively high and when the engine body is at a low temperature which is equal to or below a predetermined temperature and is under a load which is equal to or greater than a predetermined load. As a result, the vaporizability of the fuel is enhanced, and the ignitability and/or combustion stability of the air-fuel mixture are/is ensured. Meanwhile, if the content of the unconventional fuel in the fuel is relatively low, the control device instructs the fuel injection valve to inject a greater amount of the fuel during the intake stroke than during the compression stroke. Hence, the homogeneity of the air-fuel mixture is enhanced and generation of smoke is successfully reduced or avoided. As a result, the exhaust emission performance is ensured. Consequently, regardless of the properties of the fuel to be fed to the engine body, not only the ignitability and/or combustion stability of the air-fuel mixture but also the emission performance are successfully ensured constantly.

### BRIEF DESCRIPTION OF THE DRAWINGS

FIG. 1 generally illustrates a configuration of a spark-ignition engine and its control device.

FIG. 2 shows, in comparison, how the respective distillation ratios of gasoline and ethanol change with the temperature.

FIG. 3 is a map illustrating how to switch fuel injection modes, using an engine coolant temperature, an alcohol content, and a charging efficiency as parameters.

FIG. 4 shows an exemplary change in pressure in a cylinder and a timing of fuel injection.

FIG. 5 is a flowchart showing how to set a fuel injection mode.

FIG. 6 shows how a fuel augmentation rate changes as the fuel injection modes are switched according to a rise in engine coolant temperature.

FIG. 7 shows how a fuel augmentation rate changes as the fuel injection modes are switched according to the load level of the engine.

### DESCRIPTION OF EMBODIMENTS

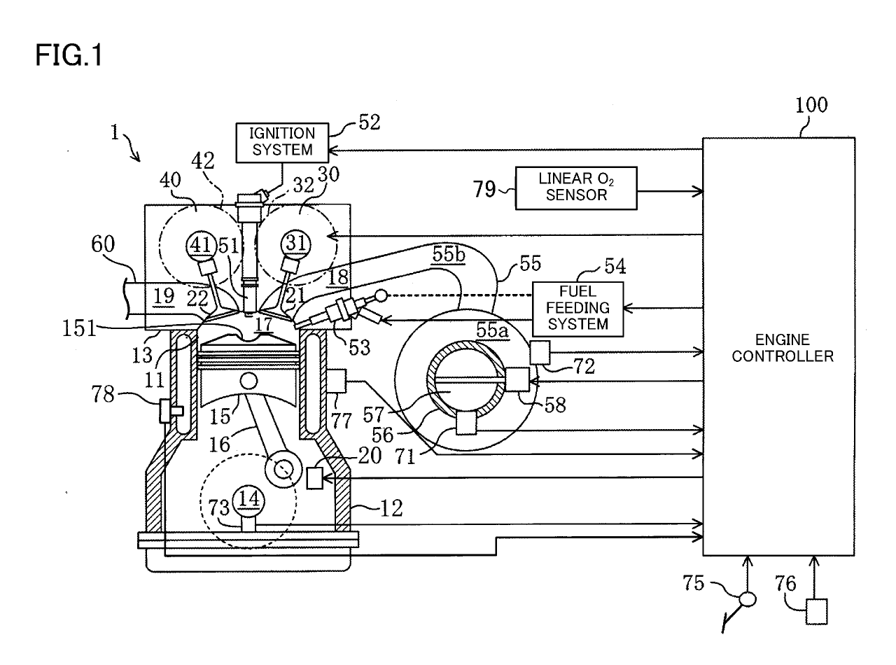

Described below with reference to the drawings is an embodiment of a spark-ignition engine. Note that the preferred embodiments to be described below are only examples. As illustrated in FIG. 1, an engine system includes: an engine (i.e., an engine body) 1; various actuators attached to the engine 1; various sensors; and an engine controller 100 which controls the actuators in response to signals supplied from the sensors. The engine 1 of this engine system has a high compression ratio (e.g., a geometric compression ratio of 12 to 1 through 20 to 1 (e.g., 12 to 1)).

The engine 1 is a spark-ignition and four-stroke internal combustion engine, and includes four cylinders 11 (i.e., a first to fourth cylinders) which are arranged in line. FIG. 1 illustrates only one of the four cylinders. Note that an engine, to which the technique disclosed herein is applicable, shall not be limited to such a four-cylinder in-line engine. The engine 1 is mounted on a vehicle such as an automobile, and has an output shaft (not shown) connected through a transmission to drive wheels. The vehicle is propelled when the power generated by the engine 1 is transmitted to the drive wheels.

This engine 1 is fed with a fuel including ethanol (such as bioethanol). In particular, this vehicle is an FFV which can run with a fuel including any ethanol content falling within the range of 25% (i.e., E25 having a gasoline content of 75%) to 100% (i.e., E100 including no gasoline at all). E100 here may include water-containing ethanol with approximately 5% of water that has not been sufficiently removed through the distillation processes of ethanol which is still left there. Note that the technique disclosed herein shall not be limited to an FFV that is supposed to use E25 to E100. The same technique is also applicable to an FFV running with a fuel, of which the ethanol content falls within the range of, for example, E0 (i.e., consisting of gasoline alone and including no ethanol at all) to E85 (i.e., a blend of an 85% ethanol and 15% gasoline).

Although not shown, this vehicle includes a fuel tank that stores the fuel described above (i.e., a main tank) only. That is to say, a feature of this vehicle is that unlike a conventional FFV, this vehicle has no other sub-tanks to store, separately from the main tank, a fuel with a high gasoline content. This FFV is built based on a gasoline-powered vehicle which runs only with gasoline. The FFV and the gasoline-powered vehicle share most of their configuration.

The engine 1 includes a cylinder block 12 and a cylinder head 13 mounted on the cylinder block 12. The cylinder block 12 has the cylinder 11 inside. As in the known art, the cylinder block 12 has a crankshaft 14 rotatably supported by a journal, a bearing and other members. This crankshaft 14 is interlocked through a connecting rod 16 with a piston 15.

Each cylinder 11 has a ceiling portion with two ramps formed to extend from an approximately middle portion of the ceiling portion to the vicinity of the bottom end face of the cylinder head 13, and the ramps lean toward each other to form a roof-like structure. This shape is what is called a “pentroof”.

Each piston 15 is slidably inserted into a corresponding cylinder 11, and defines a combustion chamber 17 along with the cylinder 11 and the cylinder head 13. The top face of the piston 15 is raised from its periphery portion toward its center portion to form a trapezoid corresponding to the pentroof shape on the ceiling face of the cylinder 11. This shape reduces the volume of the combustion chamber when the piston 15 arrives at the top dead center, and achieves as high a geometric compression ratio as 12 to 1 or more. The top face of the piston 15 has, approximately at its center, a cavity 151 which is an approximately spherical depression. The cavity 151 is positioned to face a spark plug 51 arranged in the center portion of the cylinder 11. This cavity 151 contributes to shortening one combustion period. In other words, as described above, this engine 1 having a high compression ratio has the piston 15, of which top face is raised. The engine 1 is configured so that, when the piston 15 arrives at the top dead center, the gap between the top face of the piston 15 and the ceiling face of the cylinder 11 becomes very narrow. If the cavity 151 were not formed, an initial flame would interfere with the top face of the piston 15, thus causing an increase in cooling loss, disturbing flame propagation, and resulting in a decrease in combustion speed. In contrast, this cavity 151 avoids interfering with the initial flame, and does not prevent the initial flame from growing. As a result, the flame propagation increases and the combustion period shortens. As to a fuel having a high gasoline content, such features are advantageous in reducing knocking, and contribute to an increase in torque due to advanced ignition timing.

An intake port 18 and an exhaust port 19 are provided on the cylinder head 13 of each cylinder 11, and each communicate with the combustion chamber 17. An intake valve 21 and an exhaust valve 22 are arranged to respectively shut off (i.e., close) the intake port 18 and the exhaust port 19 with respect to the combustion chamber 17. The intake valve 21 and the exhaust valve 22 are respectively driven by an intake valve driving mechanism 30 and an exhaust valve driving mechanism 40. The driven valves reciprocally move at predetermined timings to open and close the intake and exhaust ports 18 and 19.

The intake valve driving mechanism 30 and the exhaust valve driving mechanism 40 respectively include an intake camshaft 31 and an exhaust camshaft 41. The camshafts 31 and 41 are interlocked with the crankshaft 14 via a power transmission mechanism such as a known chain/sprocket mechanism. As known in the art, the power transmission mechanism rotates the camshafts 31 and 41 once while the crankshaft 14 rotates twice.

The intake valve driving mechanism 30 includes a variable intake valve timing mechanism 32 which can change the opening and closing timings of the intake valve 21. The exhaust valve driving mechanism 40 includes a variable exhaust valve timing mechanism 42 which can change the opening and closing timings of the exhaust valve 22. In this embodiment, the variable intake valve timing mechanism 32 includes a hydraulic, mechanical, or electric variable valve timing (VVT) mechanism which enables continuously changing the phase of the intake camshaft 31 within a predetermined range of angles. The variable exhaust valve timing mechanism 42 includes a hydraulic, mechanical, or electric VVT mechanism which enables continuously changing the phase of the exhaust camshaft 41 within a predetermined range of angles. The variable intake valve timing mechanism 32 changes the closing timing of the intake valve 21 to adjust an effective compression ratio. Note that the effective compression ratio refers herein to the ratio of the combustion chamber volume when the intake valve is closed to the combustion chamber volume when the piston 15 is at the top dead center.

The spark plug 51 is attached to the cylinder head 13 with screwing or any other known fixing structure. The spark plug 51 has an electrode aligned with approximate the center of the cylinder 11 and facing the ceiling portion of the combustion chamber 17. In response to a control signal from the engine controller 100, an ignition system 52 supplies an electric current to the spark plug 51 so that the spark plug 51 produces a spark at any desired ignition timing.

Using a bracket or any other known fixing member, a fuel injection valve 53 is attached to one side (i.e., to the intake side in FIG. 1) of the cylinder head 13 in this embodiment. This engine 1 directly injects fuel into the cylinder 11. In other words, the engine 1 is a so-called “direct-injection engine”. The fuel injection valve 53 has a tip positioned below the intake port 18 in the vertical direction, and at the center of the cylinder 11 in the horizontal direction. The tip protrudes into the combustion chamber 17. Note that the arrangement of the fuel injection valve 53 shall not be limited to this. In this example, the fuel injection valve 53 is a multi-hole injector (i.e., MHI) having six holes. Regarding the orientation of each hole (not shown), the tip of the injector hole expands toward its end so that the fuel is injected throughout the space inside the cylinder 11. The MHI is beneficial in that (i) the injector has multiple holes and each hole has a small diameter, which enables injecting the fuel with a relatively high pressure, and (ii) the injector injects the fuel throughout the space inside the cylinder 11, which enables mixing the fuel better and enhancing the vaporization and atomization of the fuel. Hence, injecting the fuel during the intake stroke is beneficial in terms of mixing the fuel and promoting the vaporization and atomization of the fuel by taking advantage of an intake flow in the cylinder 11. On the other hand, injecting the fuel during the compression stroke is beneficial in terms of cooling the gas in the cylinder 11, because the vaporization and atomization of the fuel are promoted. Note that the fuel injection valve 53 does not have to be the MHI.

A fuel feeding system 54 includes a high-pressure pump which raises the pressure of the fuel and supplies the high-pressure fuel to the fuel injection valve 53, members such as a pipe and a hose which send the fuel from a fuel tank to the high-pressure pump, and an electric circuit which drives the fuel injection valve 53. Note that the illustration of their configuration is omitted herein. In this example, the high-pressure pump is driven by the engine 1. Optionally, the high-pressure pump may be an electric pump. The high-pressure pump has a relatively small capacity, as in a gasoline-powered vehicle. If the fuel injection valve 53 is an MHI, the fuel injection pressure is set to be relatively high since the fuel is injected through small holes. The electric circuit activates the fuel injection valve 53 in response to a control signal from the engine controller 100, and makes the fuel injection valve 53 inject a desired amount of the fuel into the combustion chamber 17 at a predetermined timing. Here, the fuel feeding system 54 raises the fuel pressure as the number of revolutions of the engine revolution increases. Raising the fuel pressure increases the amount of fuel to be injected into the cylinder 11 with an increase in the number of revolutions of the engine. However, the high fuel pressure is advantageous in terms of the vaporization and atomization of the fuel. Besides, in the high fuel pressure also narrows the pulse width as much as possible for the fuel injection of the fuel injection valve 53. The highest fuel pressure may be 20 MPa, for example. As described above, the fuel tank stores an alcohol-containing fuel with any arbitrary ethanol content falling within the range of E25 to E100.

The intake port 18 communicates with a surge tank 55a via an intake passageway 55b in an intake manifold 55. The airflow from an air cleaner (not shown) is supplied to the surge tank 55a via a throttle body 56. The throttle body 56 is provided with a throttle valve 57. As known in the art, this throttle valve 57 reduces the airflow running into the surge tank 55a, and controls its flow rate. In response to a control signal supplied from the engine controller 100, a throttle actuator 58 adjusts the opening of the throttle valve 57.

As known in the art, the exhaust port 19 communicates with a passage in an exhaust pipe via an exhaust passageway in an exhaust manifold 60. This exhaust manifold 60 includes first collectors and a second collector (not shown). Each of the first collectors collects individual branch exhaust passageways connected to the respective exhaust ports 19 of the cylinders 11, so that the collected individual exhaust passageways are not neighboring one another in exhausting order. The second collector collects intermediate exhaust passageways provided downstream of the first collectors. That is to say, the exhaust manifold 60 of this engine 1 adopts a so-called “4-2-1 pipe layout”.

The engine 1 further includes a starter motor 20 for cranking the engine 1 at its start.

The engine controller 100 is a controller based on a known microcomputer. The engine controller 100 includes a central processing unit (CPU) which executes a program, a memory, such as a random access memory (RAM) or a read-only memory (ROM), which stores a program and data, and an input-output (I/O) bus through which an electric signal is input and output.

The engine controller 100 receives various inputs including: the flow rate and temperature of an intake airflow from an airflow sensor 71; an intake manifold pressure from an intake pressure sensor 72; a crank angle pulse signal from a crank angle sensor 73; an engine coolant temperature from a coolant temperature sensor 78; and an oxygen concentration in the exhaust gas from a linear O₂ sensor 79 attached to an exhaust passageway. The engine controller 100 calculates the number of revolutions of the engine based on, for example, a crank angle pulse signal. Moreover, the engine controller 100 receives an accelerator position signal from an accelerator position sensor 75 which detects an accelerator pedal travel. Furthermore, the engine controller 100 receives a vehicle speed signal from a vehicle speed sensor 76 which detects a rotation speed of the output shaft of the transmission. In addition, the cylinder block 12 is further provided with a knocking sensor 77 including an acceleration sensor transforming vibrations of the cylinder block 12 into a voltage signal, and outputs the voltage signal to the engine controller 100.

Based on these inputs, the engine controller 100 calculates the following control parameters for the engine 1. Examples of the control parameters include a desired throttle opening signal, fuel injection pulse, ignition signal, and phase angle signal of a valve. The engine controller 100 then outputs those signals to the throttle actuator 58, the fuel feeding system 54, the ignition system 52, the variable intake valve timing mechanism 32, the variable exhaust valve timing mechanism 42 and other members. At the start of the engine 1, the engine controller 100 further outputs a drive signal to the starter motor 20.

Here, as a configuration unique to an FFV engine system, the engine controller 100 estimates the ethanol content of the fuel to be injected by the fuel injection valve 53, based on the result of detection by the linear O₂ sensor 79. The theoretical air fuel ratio of ethanol (9.0) is smaller than that of gasoline (14.7). The higher the ethanol content of the fuel is, the richer the theoretical air fuel ratio is (i.e., the lower the theoretical air fuel ratio is). If unburned oxygen is left in the exhaust gas under the condition that the engine is run at the theoretical air fuel ratio, a determination may be made that the ethanol content of the fuel is higher than expected. Specifically, refueling the vehicle could change the ethanol content of the fuel that the fuel injection valve 53 injects (i.e., the ethanol content of the fuel stored in the fuel tank). Thus, the engine controller 100 first determines, based on a detection value obtained by a level gauge sensor of the fuel tank, whether the vehicle has been refueled. If the answer is YES, the engine controller 100 estimates the ethanol content of the fuel. Based on the output signal of the linear O₂ sensor 79, the engine controller 100 estimates an ethanol content in the fuel. Specifically, if the air fuel ratio is lean, the engine controller 100 determines that the fuel contains more gasoline. On the other hand, if the air fuel ratio is rich, the engine controller 100 determines that the fuel contain more ethanol. Note that a sensor may be provided to detect the ethanol content of the fuel, instead of estimating the ethanol content of the fuel. The ethanol content thus estimated is used for controlling fuel injection.

The engine controller 100 further calculates the vaporization rate of the fuel fed into the cylinder 11, based on the result of detection by the linear O₂ sensor 79. The vaporization rate is defined as the ratio by weight of the fuel contributing to combustion to the fuel fed into the cylinder 11 (i.e., the amount of the fuel injected by the fuel injection valve 53). The engine controller 100 calculates the weight of the fuel contributing to the combustion based on the detection value obtained by the linear O₂ sensor 79, and calculates the vaporization rate based on the calculated fuel weight and the amount of the fuel injected by the fuel injection valve 53.

### [Controlling Fuel Injection]

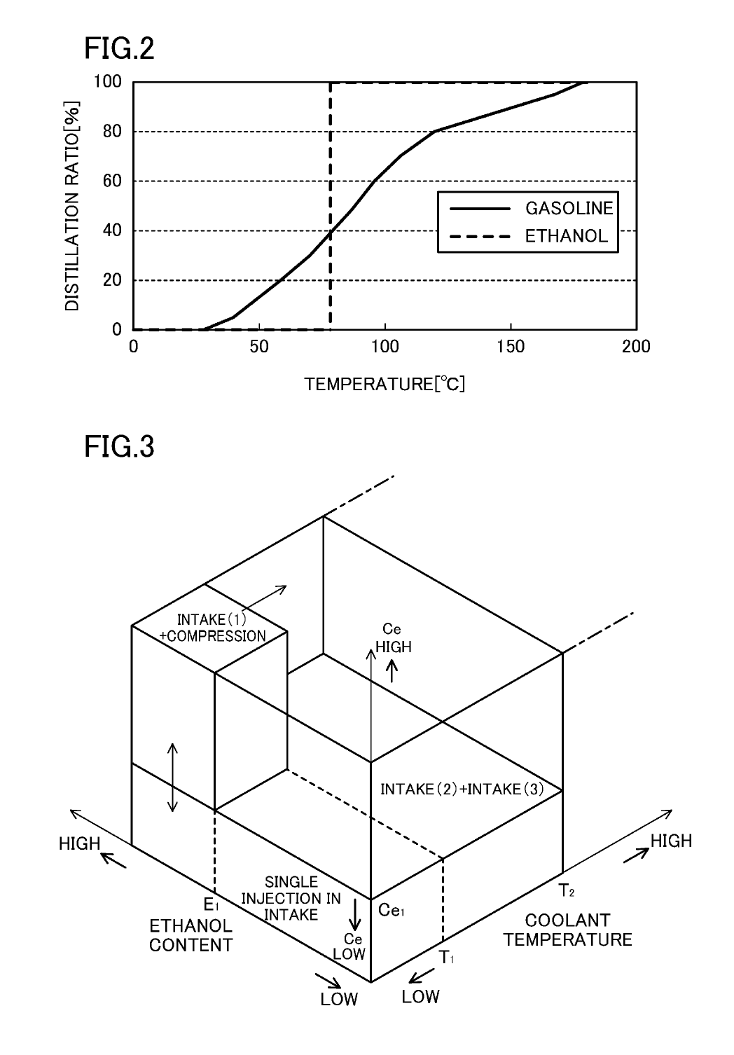

As described above, this engine system is mounted on an FFV. The engine 1 is fed with an alcohol-containing fuel, with any arbitrary ethanol content falling within the range of E25 to E100. FIG. 2 shows, in comparison, the respective vaporizabilities of gasoline and ethanol. Note that FIG. 2 shows how the distillation ratios (%) of gasoline and ethanol each change as the temperature varies under the atmospheric pressure. Gasoline is a multicomponent fuel, and evaporates in accordance with the boiling point of each component. The distillation ratio of gasoline changes approximately linearly with the temperature. Thus, some components of gasoline may vaporize to create combustible air-fuel mixture, even if the temperature of the engine 1 is relatively low.

In contrast, ethanol is a single component fuel, and its distillation ratio becomes 0% at or below a specific temperature (i.e., 78° C. that is the boiling point of ethanol). On the other hand, its distillation ratio reaches 100% once the specific temperature is exceeded. Hence, the comparison between gasoline and ethanol shows that ethanol has a lower distillation ratio than gasoline at or below the specific temperature. However, ethanol tends to have a higher distillation ratio than gasoline, once the specific temperature is exceeded. Thus, when the engine 1 is in the cold-running phase, i.e., when the temperature of the engine 1 is at or below a predetermined temperature (e.g., when the coolant temperature is less than approximately 20° C.), a fuel containing ethanol has a lower vaporization rate than gasoline. Consequently, when the engine 1 is in the cold-running phase, the vaporization rate of the fuel decreases as the temperature of the engine 1 falls and as the ethanol content of the fuel increases.

As can be seen, the vaporization rate of the fuel changes depending on the temperature of the engine 1 and the ethanol content of the fuel. Thus, in order to achieve a target amount of vaporized fuel, the engine controller 100 makes, in accordance with the vaporization of the fuel, augmenting correction to a basic fuel amount to be set based on, for example, an engine load and an alcohol content. Specifically, the fuel injection amount is set by multiplying the basic fuel amount by the fuel augmentation rate, as calculated with the expressions below. An actual vaporized fuel amount is obtained by multiplying the fuel injection amount by a vaporization rate.

[Fuel Injection Amount]=[Basic Fuel Amount]×(1+Fuel Augmentation Rate)

[Actual Vaporized Fuel Amount]=[Fuel Injection Amount]×[Vaporization Rate].

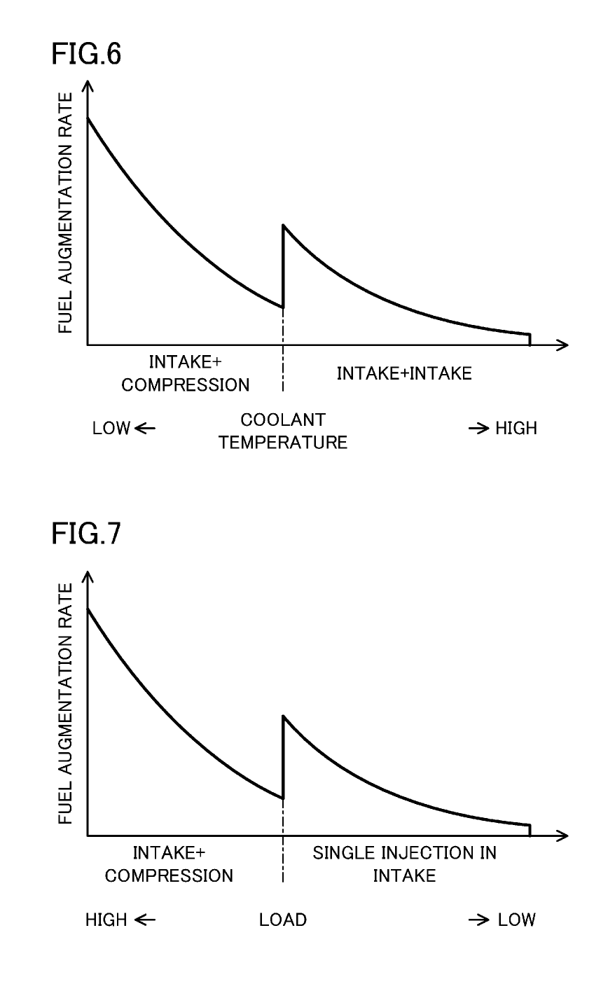

The fuel augmentation rate is preset based on a vaporization rate of each of running states of the engine, and stored in the engine controller 100. Here, the vaporization rate is obtained through, for example, experiments. Basically, the fuel augmentation rate increases as the vaporization rate falls, and decreases as the vaporization rate rises. Hence, as illustrated in FIG. 6, the fuel augmentation rate increases when the engine coolant temperature is low, and decreases when the engine coolant temperature is high. Note that the fuel augmentation rate shown in FIG. 6 or FIG. 7 will be detailed later.

Moreover, as will be described later, the vaporization rate changes, depending also on the timing of the fuel injection (i.e., whether it is injected during the intake stroke or the compression stroke). The fuel augmentation rate also changes accordingly with the vaporization rate.

Thus, the amount of the fuel to be injected by the fuel injection valve 53 increases as the vaporization rate of the fuel decreases. Hence, when the engine 1 is in the cold-running phase under a heavy load, more fuel is consumed due to the heavy load, and the magnitude of the augmenting correction to be made increases since the vaporization rate of the fuel is low. As a result, an extremely large amount of the fuel may be injected by the fuel injection valve 53. Moreover, since ethanol has a smaller theoretical air fuel ratio than gasoline, the amount of the fuel to be injected increases as the ethanol content in the fuel rises.

FIG. 3 conceptually illustrates an exemplary map of fuel injection modes, using an alcohol content of the fuel, an engine coolant temperature, and a charging efficiency as parameters. The map in FIG. 3 shows a range in which the engine coolant temperature is at or below a predetermined temperature T₂. This temperature range is equivalent to a period between the cold-running phase and the warm-up phase of the engine 1.

This engine system switches among three fuel injection modes, depending on the respective levels of the ethanol content in the fuel, an engine coolant temperature, and a charging efficiency. The fuel injection modes include: a first fuel injection mode in which the fuel is injected in each of the intake and compression strokes; a second fuel injection mode in which split injections of the fuel are performed during the intake stroke; and a third fuel injection mode in which a single injection of the fuel is performed during the intake stroke.

Specifically, the first fuel injection mode is an injection mode in which the ethanol content of the fuel is higher than a predetermined content E₁, the engine coolant temperature is at a predetermined value T₁ or less, and the charging efficiency Ce is at or above a predetermined value Ce₁. The predetermined value T₁ is approximately 20° C., for example. A case where the engine coolant temperature is equal to or lower than the predetermined value T₁ is equivalent to a case where the engine 1 is at a temperature in the cold-running phase. Furthermore, the predetermined content E₁ is 60% (i.e., E60 or higher), for example. In other words, this is equivalent to a case where the vaporization rate of the fuel is low since the engine coolant temperature is relatively low and the ethanol content is relatively high.

Moreover, the predetermined value Ce₁ is approximately 0.4, for example. Here, the engine 1 is under a relatively heavy load, and the resulting fuel injection amount is relatively large. In addition, the high ethanol content is combined with a high fuel augmentation rate caused by the low fuel vaporization rate. As a result, the fuel injection amount becomes very large. In the first fuel injection mode, such a large amount of fuel is injected into the cylinder 11 during each of the intake and compression strokes.

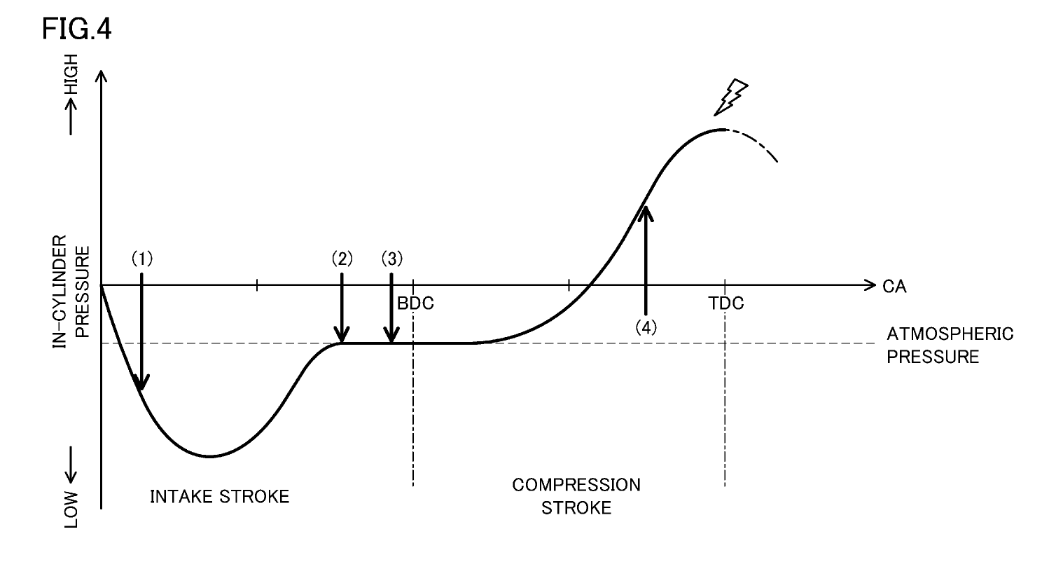

FIG. 4 shows an exemplary change in pressure in the cylinder 11 and a timing of fuel injection. As indicated by the arrow (1) in FIG. 4, the injection in the first fuel injection mode during the intake stroke may start, for example, at a point of time immediately after the intake valve 21 has opened and when the pressure in the cylinder 11 falls steeply. Taking advantage of this manifold vacuum, the first fuel injection mode promotes the vaporization of the fuel by the flash-boiling effect. Moreover, the intake stroke injection enables homogenizing the air-fuel mixture and ensuring a sufficiently long air-fuel mixture creating period.

Furthermore, as indicated by the arrow (4) in FIG. 4, the injection in the first fuel injection mode during the compression stroke may start, for example, during the second half of the compression stroke (i.e., the second half of the compression stroke when the compression stroke is virtually divided into the first and second halves). This is to promote the vaporization of the fuel by utilizing a rise in temperature in the cylinder 11 caused by the adiabatic compression during the compression stroke. As described above, this engine 1 has a high compression end temperature due to the high geometric compression ratio, and thus the compression stroke injection is very advantageous in vaporizing the fuel. During the compression stroke injection, the injection of the fuel into the cylinder 11 may be delayed until the temperature and pressure within the cylinder 11 reach such levels at which the ethanol is ready to evaporate. This allows the ethanol to vaporize immediately after having been injected into the cylinder 11. It is recommended that a sufficiently long period be provided for creating an air-fuel mixture between the end point of the fuel injection and the timing of ignition. Thus, the fuel injection may be started during the first half of the compression stroke if the fuel injection amount is so large as to take a long fuel injection period.

The second fuel injection mode is an injection mode used in a range (i) in which the charging efficiency Ce is at or above the predetermined value Ce₁ and the engine coolant temperature is at or below the predetermined value T₂, and (ii) other than the range in which the first fuel injection mode is executed. In other words, the second fuel injection mode may be regarded as a fuel injection mode used in a range in which the engine load is relatively heavy and the fuel vaporization rate is not so low. In the second fuel injection mode, even though the fuel injection amount is relatively large since the engine 1 is under a relatively heavy load, the fuel augmentation rate does not rise very high since the fuel vaporization rate is not so low. Consequently, the fuel injection amount is reduced. In the second fuel injection mode, the split injections are executed during the intake stroke.

The injection in the second fuel injection mode during the intake stroke is executed at the timings indicated by the arrows (2) and (3) in FIG. 4. These timings are later than the injection timing (1) in the first fuel injection mode during the intake stroke. As described above, the second fuel injection mode is for injecting the fuel under a condition in which the vaporization rate is not so low. Hence, the manifold vacuum does not have to be utilized for promoting the vaporization of the fuel. To the contrary, the piston 15 is located in the vicinity of the upper end in the cylinder 11 immediately after the intake valve 21 has opened. Thus, the fuel injected from the fuel injection valve 53 will collide against the top face of this piston 15. This can be disadvantageous in homogenizing the air-fuel mixture. Hence, in the second fuel injection mode, the fuel is injected into the cylinder 11 at a time point when the piston 15 moves into the lower portion of the cylinder 11 during the second half of the intake stroke. This reduces the risk of the fuel colliding against the piston 15. On the other hand, the fuel injection at this time point is beneficial in homogenizing the air-fuel mixture by utilizing a strong intake flow.

In a range where the engine coolant temperature is at or below T₁ and the charging efficiency Ce is at or above the predetermined value Ce₁, the second fuel injection mode and the first fuel injection mode switch one to the other depending on the ethanol content of the fuel. Specifically, the second fuel injection mode is executed when the ethanol content of the fuel is low (i.e., when the gasoline content is high), and the first fuel injection mode is executed when the ethanol content of the fuel is high. Ethanol has a property which does not allow so much smoke to be generated as gasoline does, since the combustion temperature of the ethanol is relatively low and the molecules of the ethanol include oxygen. Because of this property, smoke is hardly generated when the ethanol content is high, even if the fuel is injected during the compression stroke as in the first fuel injection mode. Thus, when the ethanol content is relatively high, it is beneficial to execute the compression stroke injection to promote the vaporization of the fuel.

To the contrary, it will affect the homogeneity of the air-fuel mixture disadvantageously to inject the fuel into the cylinder during the compression stroke. Hence, if the compression stroke injection is executed when the gasoline content of the fuel is high, there could be a risk of generating smoke. Hence, when the ethanol content is relatively low, the intake stroke injection alone is executed, without executing the compression stroke injection, so that the generation of smoke may be avoided.

The third fuel injection mode is an injection mode in which the charging efficiency Ce is below the predetermined value Ce₁. Since the charging efficiency is relatively low, the opening of the throttle valve 57 is decreased, so that relatively high manifold vacuum is obtained. Hence, the vaporization of the fuel is successfully promoted by taking advantage of the obtained manifold vacuum thanks to the flash-boiling effect, regardless of the respective levels of the engine coolant temperature and the ethanol content (i.e., regardless of the level of the vaporization rate). In the third fuel injection mode, a single injection is executed during the intake stroke. In order to use the manifold vacuum effectively, the starting point of the fuel injection may be set during the first half of the intake stroke.

In this manner, regardless of the properties of the fuel to be fed to the engine 1, not only the ignitability and/or combustion stability of the air-fuel mixture but also the exhaust emission performance are successfully ensured.

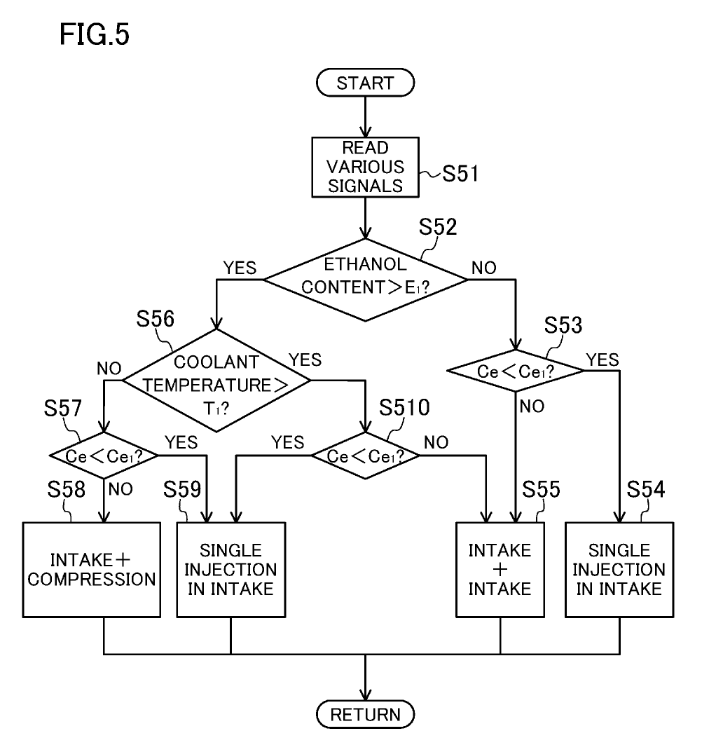

FIG. 5 is a flowchart showing how to set a fuel injection mode. The process in the flowchart is executed by the engine controller 100. The engine controller 100 reads various signals in Step S51 after the start. In the next Step S52, determination is made whether an estimated ethanol content exceeds a predetermined value E₁. If the estimated ethanol content is equal to or below the predetermined value E₁ (i.e., if the answer is NO), the process proceeds to Step S53. On the other hand, if the estimated ethanol content exceeds the predetermined value E₁ (i.e., if the answer is YES), the process proceeds to Step S56.

In Step S53, a determination is made whether the charging efficiency is below the predetermined value Ce₁. If the charging efficiency is below the predetermined value Ce₁ (i.e., if the answer is YES), the process proceeds to Step S54, and the fuel injection mode is set to be the third fuel injection mode, that is, a single injection during the intake stroke. On the other hand, if the charging efficiency is equal to or above the predetermined value Ce₁ (i.e., if the answer is NO), the process proceeds to Step S55, and the fuel injection mode is set to be the second fuel injection mode, that is, split injections during the intake stroke.

Meanwhile, in Step S56 to which the process proceeds when the ethanol content is determined to be above the predetermined value, a determination is made whether the engine coolant temperature exceeds the predetermined value T₁. If the engine coolant temperature exceeds the predetermined value T₁ (i.e., if the answer is YES), the process proceeds to Step S510. In Step S510, a determination is made whether the charging efficiency is below the predetermined value Ce₁. If the answer is YES, the process proceeds to Step S59, and the fuel injection mode is set to be the third fuel injection mode (i.e., a single injection during the intake stroke). On the other hand, if the answer is NO, the process proceeds to Step S55 and the fuel injection mode is set to be the second fuel injection mode (i.e., split injections during the intake stroke).

If the engine coolant temperature turns out to be at or below the predetermined value T₁ in Step S56 (i.e., if the answer is NO), the process proceeds to Step S57. In this Step 57 too, a determination is made again whether the charging efficiency is below the predetermined value Ce₁. If the answer is YES in Step S57, the process proceeds to Step S59, and the fuel injection mode is set to be the third fuel injection mode (i.e., a single injection during the intake stroke). On the other hand, if the answer is NO, the flow proceeds to Step S58, and the fuel injection mode is set to be the first fuel injection mode (i.e., split injections during the intake and compression strokes).

Thus, the fuel injection modes are switched from one to the other depending on the level of the engine coolant temperature. Thus, the fuel injection modes switch as the temperature of the engine coolant changes, more specifically, as the coolant temperature gradually rises after a cold start of the engine 1. In particular, as indicated by the arrow in FIG. 3, modes are switched from the first fuel injection mode (i.e., a split injections during the intake and compression strokes) to the second fuel injection mode (i.e., split injections during the intake stroke), if the engine coolant temperature rises when the ethanol content exceeds the predetermined value E₁ and when the charging efficiency Ce exceeds the predetermined value Ce₁. Once this switch has been made, the compression stroke injection, which has been performed before the switch, is no longer performed. As described above, the compression stroke injection promotes the vaporization of the fuel by utilizing the temperature in the cylinder. Enabling or disabling the compression stroke injection will make a big difference in the vaporization rate of the fuel injected into the cylinder 11. Specifically, when the engine coolant temperature rises, the vaporization rate decreases steeply at the stop of the compression stroke. Due to this steep decrease in the vaporization rate, an actual vaporized fuel amount becomes insufficient immediately after the switch to the second fuel injection mode because of the difference in vaporization rate even if the same amount of the fuel is injected before and after the switch. As a result, the air fuel ratio turns lean with respect to a theoretical air fuel ratio. In such a state, a torque to be generated will decrease, causing a torque shock at the time of switching the fuel injection modes.

Here, in engine control, such a torque shock involved with switching the modes of controls is reduced through an adjustment of ignition timing, for example. As described above, however, this torque shock is originally due to an insufficient amount of the vaporized fuel, and controlling the ignition timing, for example, cannot reverse the torque decrease.

Thus, as illustrated in FIGS. 6 and 7, this engine system discontinuously changes the fuel augmentation rate before and after the switch of fuel injection modes. Specifically, the ordinate of FIG. 6 represents the engine coolant temperature. The engine coolant temperature decreases comparatively toward the left of the paper, and increases comparatively toward the right of the paper. Hence, the engine coolant temperature changes from the left to the right of the paper after the cold start of the engine 1. The engine 1 is under a running state in which the ethanol content of the fuel is higher than the predetermined value E₁, and the charging efficiency Ce is higher than the predetermined value Ce₁. Thus, on the left-hand side of FIG. 6, split injections are executed during the intake and compression strokes (i.e., the first fuel injection mode). On the right-hand side of FIG. 6, split injections are executed during the intake stroke (i.e., the second fuel injection mode).

First, under a condition in which the first fuel injection mode is executed, the vaporization rate rises as the engine coolant temperature rises. Thus, the fuel augmentation rates are set to be gradually decreasing values. At the time of switching the fuel injection modes, as described above, the fuel augmentation rate, which has been decreasing until then, increases steeply in response to the steep decrease in vaporization rate. Hence, the fuel injection amount significantly increases immediately after the modes have been switched from the first fuel injection mode into the second fuel injection mode. Thus, even if the vaporization rate decreases without executing the compression stroke injection, a required amount of vaporized fuel is still ensured successfully. Consequently, the shortage of the vaporized fuel immediately after the switch, and eventually the torque shock, are avoidable. After that, also under a condition in which the second fuel injection mode is executed, the vaporization rate rises as the engine coolant temperature rises. As a result, the fuel augmentation rates are set to be gradually decreasing values.

Here, as can be seen clearly from the map in FIG. 3, the fuel injection modes are switched not only when the engine coolant temperature rises. Specifically, if the load on the engine 1 decreases from a heavy load to a light load when the ethanol content exceeds the predetermined value E₁ and the engine coolant temperature is at or below the predetermined value T₁, the fuel injection modes switch from the first fuel injection mode to the third fuel injection mode. To the contrary, if the load on the engine 1 increases from a light load to a heavy load, the fuel injection modes switch from the third fuel injection mode to the first fuel injection mode.

At these timings of switching, too, enabling and disabling the compression stroke injection are changed, thus causing a steep change in the vaporization rate of the fuel injected into the cylinder 11. Specifically, FIG. 7 shows that, as the engine load decreases, the manifold vacuum increases. As a result, the vaporization rate rises, and the fuel augmentation rates are set to be gradually decreasing values. After that, when the charging efficiency Ce becomes equal to or lower than the predetermined value Ce₁, modes are switched from the first fuel injection mode in which split injections, including the intake stroke and compression stroke injections, are executed to the third fuel injection mode in which a single injection is executed during the intake stroke. Immediately after this timing of switching, the vaporization rate decreases steeply as described above. Hence, the fuel augmentation rate is increased steeply. Specifically, the fuel augmentation rates are switched discontinuously, thereby increasing the fuel injection amount, even though the engine load is decreasing. Such operations ensure a required vaporized fuel amount and reduce the torque shock. Even under a condition that the third fuel injection mode is executed, too, the vaporization rate rises as the engine load decreases. As a result, the fuel augmentation rates are set to be gradually decreasing values. To the contrary, when the engine load increases and the charging efficiency Ce exceeds the predetermined value Ce₁, the third fuel injection mode, in which a single injection is executed during the intake stroke, switches to the first fuel injection mode in which split injections, including the intake stroke and compression stroke injections, are executed. Immediately after the timing of switching, the vaporization rate increases steeply to the situation just described. Hence, the fuel augmentation rate is decreased steeply. That is to say, the fuel augmentation rates are switched discontinuously, thereby decreasing the fuel injection amount, even though the engine load is increasing. Such operations avoid creating an excessive amount of vaporized fuel, and reduce the torque shock.

Note that, according to the configuration described above, split injections, including the intake stroke and compression stroke injections, are executed in the first fuel injection mode, and split injections during the intake stroke alone, not the compression stroke injection, is executed in the second fuel injection mode. However, the split injections, including the intake stroke and compression stroke injections, may be executed in the second fuel injection mode. In addition, the ratio of the injection amount in the intake stroke injection to that in the compression stroke injection may be set differently between the first and second fuel injection modes. In particular, in the first fuel injection mode in which the vaporization rate of the fuel is relatively low, the injection amount in the compression stroke injection may be set to be greater than that in the intake stroke injection, and then the split injections, including the intake stroke and the compression stroke injections, may be executed. In the second fuel injection mode in which the vaporization rate of the fuel is relatively high, the injection amount in the intake stroke injection may be set to be greater than that in the compression stroke injection, and then the split injections, including the intake stroke and the compression stroke injections, may be executed.

Moreover, in addition to the fuel injection valve 53 of direct injection type, a fuel injection valve may further be provided to inject the fuel into the intake port.

### INDUSTRIAL APPLICABILITY

### Description of Reference Characters

1. Engine (Engine Body)
11. Cylinder
100 Engine Controller
53 Fuel Injection Valve
54 Fuel Feeding System (Fuel Feeder)

1. A control device for a spark-ignition engine, the device comprising:
an engine body configured to run with a fuel including at least one of gasoline and an unconventional fuel, of which the vaporization rate is lower, at or below a specific temperature, than that of the gasoline;
a fuel feeder which includes a fuel injection valve injecting the fuel, and is configured to feed the fuel through the fuel injection valve into a cylinder provided for the engine body;
a throttle valve configured to have an increased opening when the engine body is under a heavy load, and a decreased opening when the engine body is under a light load; and
a controller configured to operate the engine body by controlling at least the fuel feeder, wherein
the controller is configured to:
allow the fuel to be fed into the cylinder, within a range from an intake stroke to a compression stroke, if the engine body is at a low temperature which is equal to or below a predetermined temperature, and is under a load which is equal to or greater than a predetermined load, and instruct the fuel injection valve (i) to inject a greater amount of the fuel during the compression stroke than during the intake stroke if the content of the unconventional fuel in the fuel is higher than a predetermined level, and (ii) to inject a greater amount of the fuel during the intake stroke than during the compression stroke if the content of the unconventional fuel in the fuel is equal to or lower than the predetermined level; and
allow the fuel to be fed into the cylinder during the intake stroke, no matter whether the content of the unconventional fuel in the fuel is high or low, if the engine body is at the low temperature that is equal to or below the predetermined temperature, and is under a load which is smaller than the predetermined load.

2. The device of claim 1, wherein
the controller is configured to allow the fuel to be injected during both the intake and compression strokes if the content of the unconventional fuel is higher than the predetermined level, and to allow the fuel to be injected during the intake stroke alone if the content of the unconventional fuel is equal to or lower than the predetermined level.

3. The device of claim 2, wherein
the fuel injection valve directly injects the fuel into the cylinder,
if the content of the unconventional fuel is higher than the predetermined level, the controller is configured to allow the fuel to be injected through the fuel injection valve into the cylinder during a first period of the intake stroke and during the compression stroke, and
if the content of the unconventional fuel is equal to or lower than the predetermined level, the controller is further configured to allow the fuel to be injected through the fuel injection valve into the cylinder during each of a second period and a third period of the intake stroke, the second and third periods being later than the first period.

4. The control device of claim 1, wherein
the controller is configured to allow a single injection of the fuel to be executed during the intake stroke if the engine body is under a lighter load than the predetermined load.
